(19) United States
(12) Patent Application Publication
(10) Pub. No.: US 2020/0329889 A1
(43) Pub. Date: Oct. 22, 2020

(54) Hanging-Board-and-Hook-Member Connecting Structure

(71) Applicant: Tanko Organize Company, New Taipei City (TW)

(72) Inventor: Shih-Chiao WEN, New Taipei City (TW)

(73) Assignee: Tanko Organize Company

(21) Appl. No.: 16/385,780

(22) Filed: Apr. 16, 2019

(51) Int. Cl. A47F 5/08; F16B 17/00

(52) U.S. Cl. CPC A47F 5/0823; F16B 17/00

(57) ABSTRACT

A hanging-board-and-hook-member connecting structure includes a body and a hook member. The body is additionally provided with upper and lower elastic portions which are used to abut against the hanging board. The hanging-board-and-hook-member connecting structure has a simple structure and can improve the flexibility and convenience of disassembly and assembly, and can be mounted on hanging boards of different thicknesses. The disassembling and assembling process causes no deformation and fracture, making the assembling and disassembling easier without damaging the surface of the components. Besides, both the upper and lower elastic portions have elasticity, which allows for easy disassembling of the upper elastic portion and adjustment of the lower elastic portion.

### BACKGROUND

### Field of the Invention

The present invention relates to a connecting structure, and more particularly to a hanging-board-and-hook-member connecting structure.

### Related Prior Art

Please refer to FIG. 1, a common storage structure generally includes a hanging board 1 and a plurality of hook members 2 (only one hook member is shown), and the hanging board 1 is provided with a plurality of mounting holes 3 for insertion of an elastic portion 4 of the hook members 2 so as to fix the hook members 2 to the hanging board 1.

However, for such a conventional design, the elastic portion 4 of the hook member 2 can be assembled to the mounting hole 3 of the hanging board 1 (only a set of hook member 2 and mounting hole 3 is described for easy explanation), but such a manner of assembling is not easy to carry out, and the process is time consuming and laborious. It has to press a pressing portion 5 on the hook member in order to smoothly assemble and disassemble the elastic portion 4, so that the user has no basis for exerting force when assembling and disassembling, if the force is too large, problems such as deformation and breakage of the hook member 2 may occur, or if the force is insufficient, the hook member 2 cannot be reliably disassembled from and assembled on the hanging board 1. The assembling and disassembling are difficult, when the hook member 2 is assembled to or disassembled from the hanging board 1, the outer surfaces of the two might even be scratched or get jammed.

Furthermore, in the step of disassembling the hook member 2 from the hanging board 1, the user has to press the pressing portion 5 and then the hook member 2, and then pull the hook member 2 upwards, and only by that, the hook member 2 can be disassembled from the mounting hole 3 of the hanging board 1. The above-mentioned step of disassembling is quite difficult and cumbersome, which is not only laborious and time consuming, but also the process is rather unsmooth.

In addition, due to the design of the hook member 2 and the elastic portion 4, it is necessary to use the hanging board 1 whose thickness right conforms to the elastic portion 4 to allow snapping of the elastic portion 4 in the hanging board 1. If the thickness of the hanging board 1 is larger than the range in which the elastic portion 4 of the hook member 2 can be snapped in, the hook member 2 cannot be assembled, or if the thickness of the hanging board 1 is smaller than the range in which the elastic portion 4 of the hook member 2 can be snapped in, the hook member 2 can be assembled but may wobble due to the fact that the elastic portion 4 does not conform to the thickness of the hanging board 1.

Therefore, in the past, in order to solve this problem, it has to constantly produce different types of hook members 2 in order to match with the hanging board 1 of different thicknesses, which causes the cost to rise continuously, and each hook member 2 can only be matched with the hanging board of one size, so that the user cannot freely replace the hook member 2 between the hanging board 1 of different thicknesses at any time.

The present invention has arisen to mitigate and/or obviate the afore-described disadvantages.

### SUMMARY

One objective of the present invention is to provide a hanging-board-and-hook-member connecting structure which can be easily assembled to or disassembled from different hanging boards, thereby improving the convenience of assembly and disassembly while widening the applicability of the hook members.

To achieve the above objective, a hanging-board-and-hook-member connecting structure provided by the present invention is suitable for use in a hanging board having a mounting surface, a first mounting hole penetrating the mounting surface, and a second mounting hole penetrating the mounting surface, the first mounting hole includes a first hole edge, the second mounting hole has a second hole edge, the hanging-board-and-hook-member connecting structure comprises:

a body hanged to the first mounting hole and the second mounting hole of the hanging board, and including: a first surface facing the mounting surface, a second surface opposite to the first surface, at least one lower hanging portion protruding from the first surface and capable of abutting against the first hole edge, at least one upper hanging portion protruding from the first surface and capable of abutting against the second hole edge, an upper elastic portion extending from the at least one upper hanging portion and capable of abutting against the hanging board, and a lower elastic portion extending from the at least one lower hanging portion and capable of abutting against the hanging board.

Preferably, the body includes an insertion hole penetrating the first and second surfaces, an insertion groove recessed from the first surface toward the second surface, and two opposite positioning block portions protruded from the second surface and located below the insertion hole, a hook member is replaceably inserted in the insertion hole, and includes: an engaging end portion to be engaged in the insertion groove, a hanging end portion opposite to the engaging end portion, and an engaging portion connecting the engaging end portion and the hanging end portion and to be engaged with the two positioning block portions.

Preferably, the hanging end portion is a circular hole or is bent upward in a semi-arc shape.

Preferably, the body is provided with an extension hole penetrating the first surface and the second surface, and the extension hole has an integrally formed hanging end portion extending from a lower outer edge of the extension hole.

Preferably, the body is provided on the first surface with two said lower hanging portions and two said upper hanging portions located above the two lower hanging portions, the body has a first insertion hole and a second insertion hole penetrating the first and second surfaces, and a first hook member and a second hook member are respectively inserted through the first and second insertion holes.

In this way, the present invention provides a hanging-board-and-hook-member connecting structure, wherein the body is additionally provided with upper and lower elastic portions which are used to abut against the hanging board. The hanging-board-and-hook-member connecting structure has a simple structure and can improve the flexibility and convenience of disassembly and assembly, and can be mounted on hanging boards of different thicknesses. The disassembling and assembling process causes no deformation and fracture, making the assembling and disassembling easier without damaging the surface of the components. Besides, both the upper and lower elastic portions have elasticity, which allows for easy disassembling of the upper elastic portion and adjustment of the lower elastic portion.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a schematic view showing that a conventional hook member mounted on a hanging board;

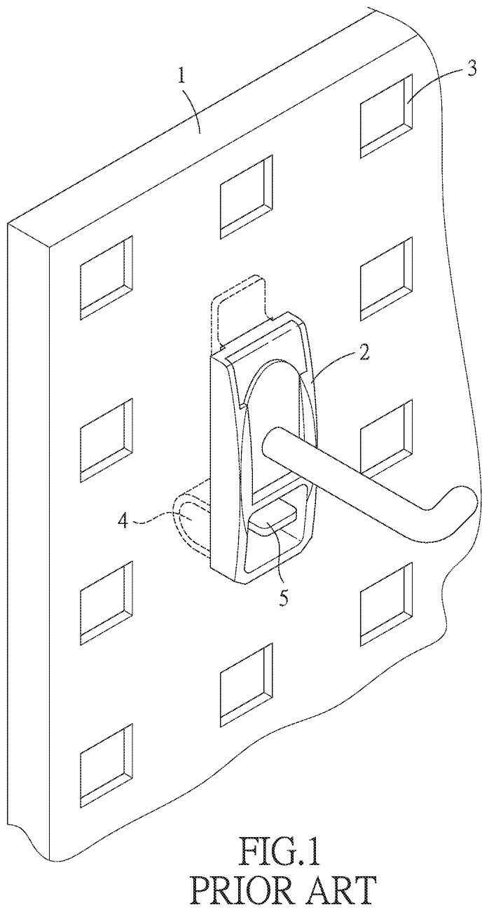

FIG. 2 is a structural view of the first embodiment of the present invention;

FIG. 3 is an exploded view of the first embodiment of the present invention;

FIG. 4A is an assembly view (1) of the first embodiment of the present invention;

FIG. 4B is an assembly view (2) of the first embodiment of the present invention;

FIG. 4C is an assembly view (3) of the first embodiment of the present invention;

FIG. 5 is a structural view showing a second embodiment of the present invention; and

FIG. 6 is a structural view of a third embodiment of the present invention.

### DETAILED DESCRIPTION

The present invention will be clearer from the following description when viewed together with the accompanying drawings, which show, for purpose of illustrations only, the preferred embodiment in accordance with the present invention.

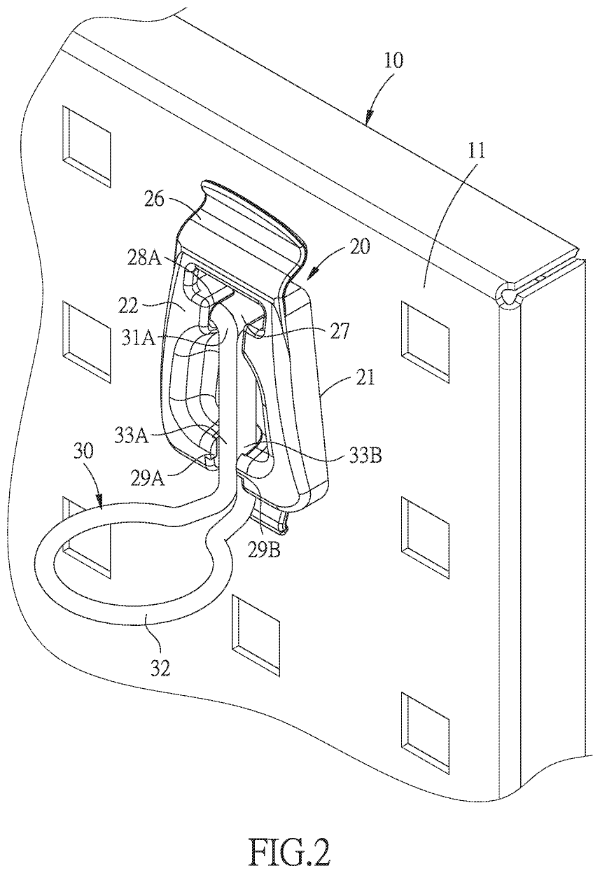

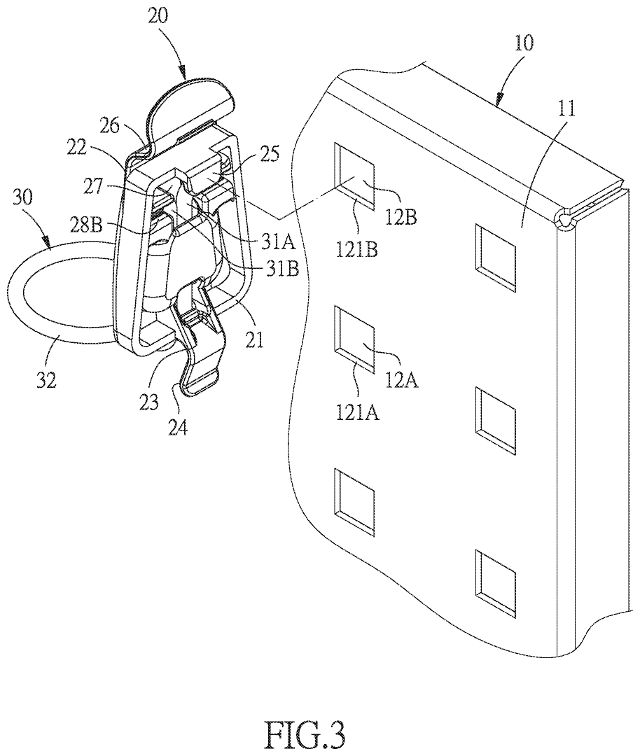

Referring to FIGS. 2 to 4C, the first embodiment of the present invention provides a hanging-board-and-hook-member connecting structure, which is suitable for use in a hanging board 10, and includes a body 20 and a hook member 30. The following is only for a set of a single body 20 and a single hook member 30, but is not limited by this embodiment, it can also be a plurality of bodies 20 and a plurality of hook members 30, among them:

The hanging board 10 is approximately rectangular parallelepiped, and includes a mounting surface 11, a first mounting hole 12A penetrating the mounting surface 11, and a second mounting hole 12B penetrating the mounting surface 11 and located above the first mounting hole 12A. The first and second mounting holes 12A, 12B are square. The first mounting hole 12A has a first hole edge 121A located at the bottom of the first mounting hole 12A. The second mounting hole 12B has a second hole edge 121B located at the bottom of the second mounting hole 12B.

The body 20 is hanged to the first mounting hole 12A and the second mounting hole 12B of the hanging board 10, and includes: a first surface 21 facing the mounting surface 11, a second surface 22 opposite to the first surface 21, a lower hanging portion 23 protruding from the first surface 21 and capable of abutting against the first hole edge 121A, a lower elastic portion 24 extending from the lower hanging portion 23 and capable of abutting against the hanging board 10, an upper hanging portion 25 protruding from the first surface 21 and capable of abutting against the second hole edge 121B, an upper elastic portion 26 extending from the upper hanging portion 25 and capable of abutting against the hanging board 10, an insertion hole 27 penetrating the first surface 21 and the second surface 22, a first insertion groove 28A and a second insertion grooves 28B which are oppositely arranged and recessed from the first surface 21 toward the second surface 22, and a first positioning block portion 29A and a second positioning block portion 29B oppositely protruded from the second surface 22 and located below the insertion hole 27. The lower and upper hanging portions 23, 25 are approximately L-shaped. Specifically, to remove the body 20 from the hanging board 10, the user can pull open the upper elastic portion 26 to remove the upper hanging portion 25 and the lower elastic portion 24 from the first and second mounting holes 12A, 12B of the hanging board 10 respectively.

The hook member 30 is formed by bending a steel rod, can be replaceably inserted in the insertion hole 27, and includes: a first engaging end portion 31A to be engaged in the first insertion groove 28A, a second engaging end portion 31B of the second insertion groove 28B, a hanging end portion 32 opposite to the first and second engaging end portions 31A, 31B, a first engaging portion 33A connecting the first engaging end portion 31A and the hanging end portion 32 and to be engaged with the first positioning block portion 29A, and a second engaging portion 33B connecting the second engaging end portion 31B and the hanging end portion 32 and to be engaged with the second positioning block portion 29B.

The first and second engaging portions 33A, 33B are respectively engaged with the first and second positioning block portions 29A, 29B to minimize the overall wobble. Specifically, the hanging end portion 32 is exemplified by a circular hole, but is not limited thereto, or is bent upward in a semi-arc shape. Through the design of the hook member 30 being replaceable, it can improves the conventional structure of single type, thereby making the application of the present invention more flexible, more wide and more practical.

The assembling of the hanging-board-and-hook-member connecting structure comprises the following steps:

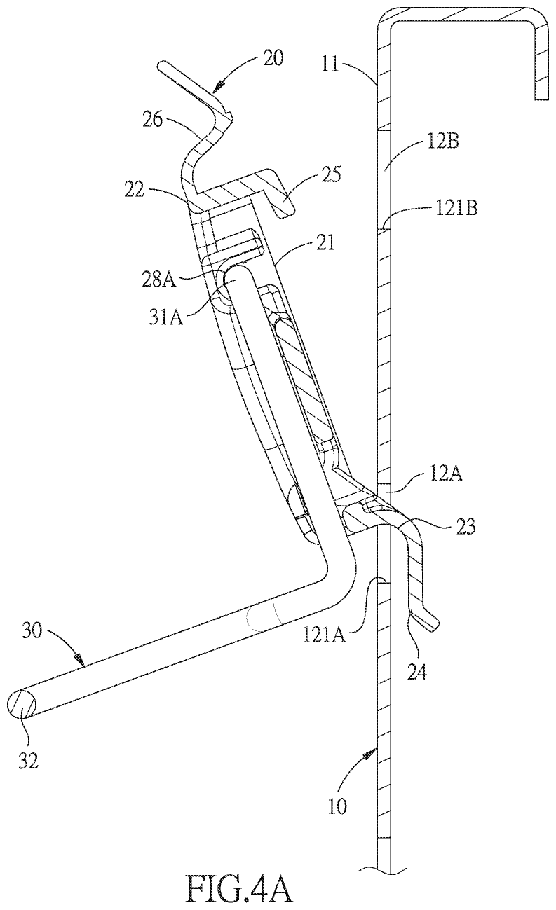

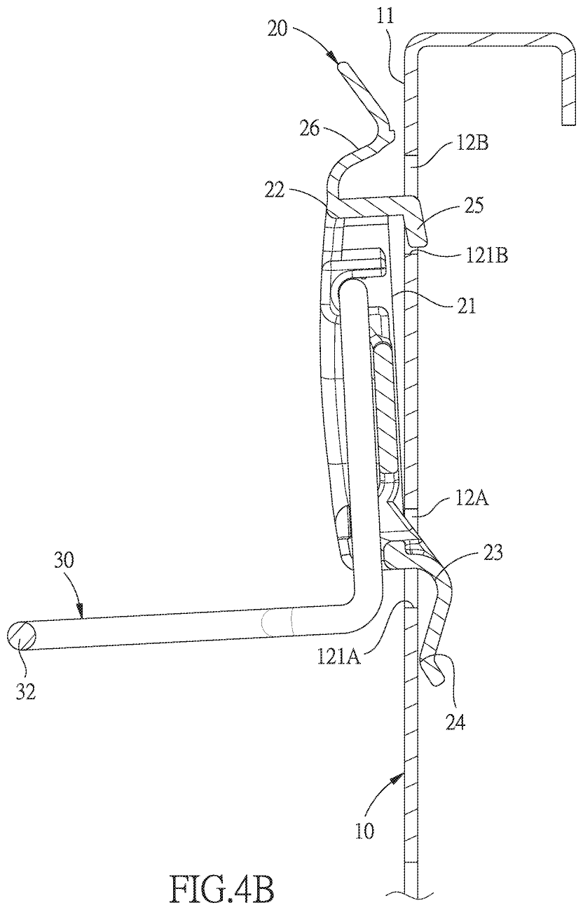

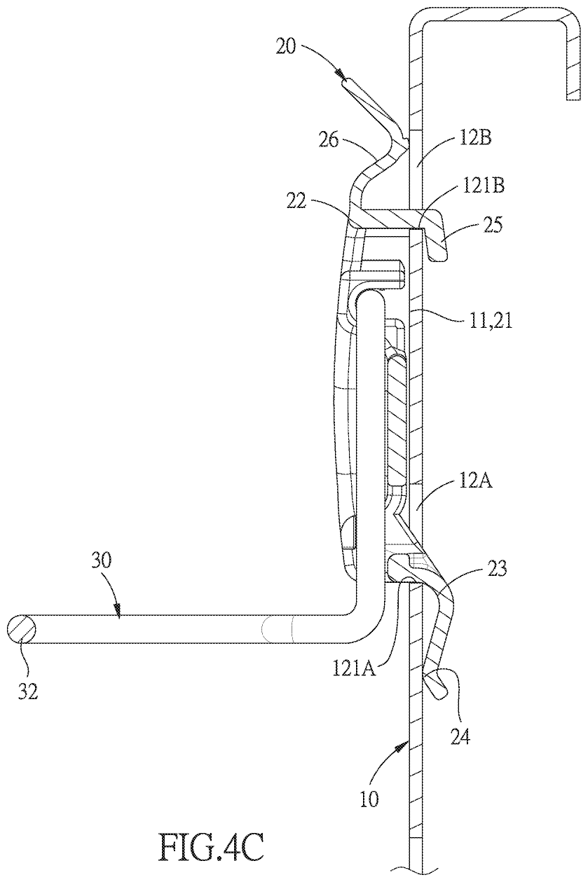

As shown in FIGS. 4A to 4C, step 1: inserting the lower hanging portion 23 of the body 20 through the first mounting hole 12A of the hanging board 10 and abutting it against the first hole edge 121A of the first mounting hole 12A; step 2: inserting the upper hanging portion 25 of the body 20 through the second mounting hole 12B of the hanging board 10 and abutting it against the second hole edge 121B of the second mounting hole 12B; step 3: at this moment, the upper elastic portion 26 and the lower elastic portion 24 abut against the hanging board 10 to achieve the effect of positioning and stabilization to prevent the body 20 from moving and wobbling. Compared with the conventional assembly method, the body 20 of the present invention has a simple structure and improves the ease and convenience of disassembly and assembly, making it suitable for hanging boards of different sizes different thicknesses.

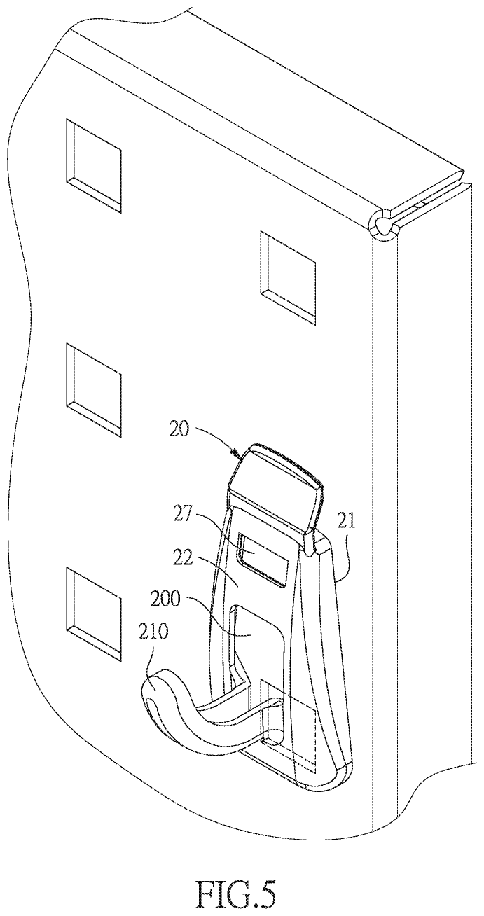

Referring to FIG. 5, which is a second preferred embodiment of the present invention. The configuration and the function of this embodiment are the same as those of the above embodiment, and therefore are not further elaborated. The difference of the second embodiment from the first embodiment is that: the body 20 is provided with an extension hole 200 penetrating the first surface 21 and the second surface 22. The extension hole 200 is located below the insertion hole 27, and has an integrally formed hanging end portion 210 extending from a lower outer edge of the extension hole 200. The body 20 and the hanging end portion 210 are made of plastic material, in this way, the hanging end portion 210 is an integral structure, which simplifies the process of manufacturing and assembly and reduces the cost.

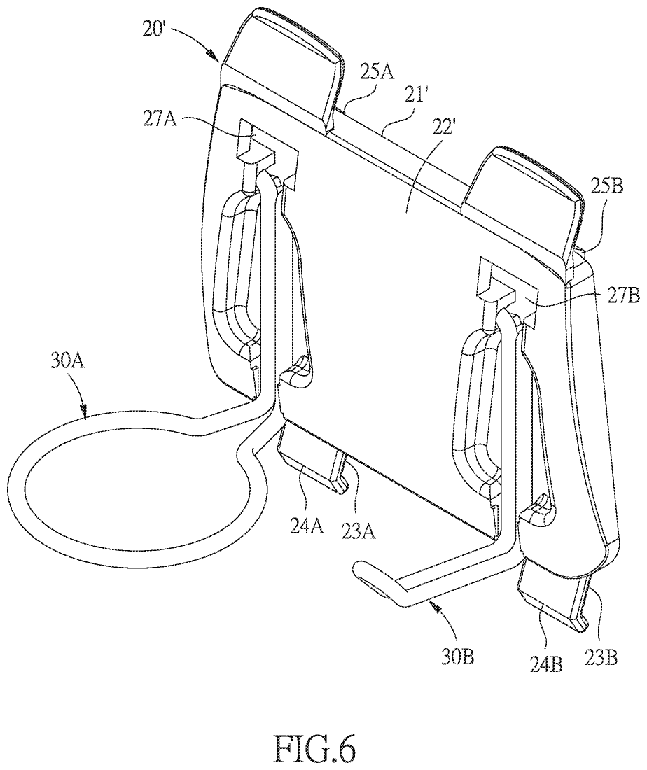

Referring to FIG. 6, which is a third preferred embodiment of the present invention. The configuration and the function of this embodiment are the same as those of the above embodiment, and therefore are not further elaborated. The difference of the third embodiment from the first embodiment is that: the body 20′ is provided on the first surface 21′ with two lower hanging portions 23A, 23B, and two upper hanging portions 25A, 25B located above the two lower hanging portions 23A, 23B.

One of the lower hanging portions 23A has a lower elastic portion 24A, and the other lower hanging portion 23B has a lower elastic portion 24B. The body 20′ has a first insertion hole 27A and a second insertion hole 27B penetrating the first and second surfaces 21′, 22′. The hanging-board-and-hook-member connecting structure further comprises a first hook member 30A and a second hook member 30B which are respectively inserted through the first and second insertion holes 27A, 27B. Through the above-mentioned structural design, the present invention is diversified, and the user can choose according to preference to match the indoor home environment, which can achieve the same effect as above.

What mentioned above re the structural relations of the main components of the embodiments of the present invention, and for the operation and effects of the present invention are explained as follows:

The present invention has a simple structure and can improve the flexibility and convenience of disassembly and assembly. The disassembling and assembling process causes no deformation and fracture, so that the present invention can be easily disassembled and assembled without damaging the surface of the components, which further improves the smoothness of disassembly and assembly. Besides, the design of the upper and lower elastic portions makes one hook member suitable for hanging boards of various thicknesses.

While we have shown and described various embodiments in accordance with the present invention, it is clear to those skilled in the art that further embodiments may be made without departing from the scope of the present invention.

1. A hanging-board-and-hook-member connecting structure being suitable for use in a hanging board having a mounting surface, a first mounting hole penetrating the mounting surface, and a second mounting hole penetrating the mounting surface, the first mounting hole having a first hole edge, the second mounting hole having a second hole edge, the hanging-board-and-hook-member connecting structure comprising:
a body hanged to the first mounting hole and the second mounting hole of the hanging board, and including: a first surface facing the mounting surface, a second surface opposite to the first surface, at least one lower hanging portion which protrudes from the first surface and is bent downward and capable of abutting against the first hole edge, at least one upper hanging portion which protrudes from the first surface and is bent downward and capable of abutting against the second hole edge, an upper elastic portion extending from the at least one upper hanging portion and capable of abutting against the hanging board, and a lower elastic portion extending from the at least one lower hanging portion and capable of abutting against the hanging board;
wherein the body includes an insertion hole penetrating the first and second surfaces, an insertion groove recessed from the first surface toward the second surface, and two opposite positioning block portions protruded from the second surface and located below the insertion hole, a hook member is replaceably inserted in the insertion hole, and includes: an engaging end portion to be engaged in the insertion groove, a hanging end portion opposite to the engaging end portion, and an engaging portion connecting the engaging end portion and the hanging end portion and to be engaged with the two positioning block portions.

2. (canceled)

3. The hanging-board-and-hook-member connecting structure as claimed in claim 1, wherein the hanging end portion is a circular hole or is bent upward in a semi-arc shape.

4. The hanging-board-and-hook-member connecting structure as claimed in claim 1, wherein the body is provided with an extension hole penetrating the first surface and the second surface, and the extension hole has an integrally formed hanging end portion extending from a lower outer edge of the extension hole.

5. The hanging-board-and-hook-member connecting structure as claimed in claim 1, wherein the body is provided on the first surface with two said lower hanging portions and two said upper hanging portions located above the two lower hanging portions, the body has a first insertion hole and a second insertion hole penetrating the first and second surfaces, and a first hook member and a second hook member are respectively inserted through the first and second insertion holes.
